(19) United States
(12) Patent Application Publication
(10) Pub. No.: US 2025/0138229 A1
(43) Pub. Date: May 1, 2025

(54) OPTICAL FILTER

(71) Applicant: PLATINUM OPTICS TECHNOLOGY INC., Taoyuan City (TW)

(72) Inventors: CHI-CHIEH WANG, Taoyuan City (TW); CHIEN-MIN HUANG, Taoyuan City (TW); KUANG-PING HUANG, Taoyuan City (TW); REN-JIE WONG, Taoyuan City (TW)

(21) Appl. No.: 18/594,068

(22) Filed: Mar. 4, 2024

(30) Foreign Application Priority Data
Oct. 27, 2023 (TW) 112141164

(51) Int. Cl. G02B 5/28

(52) U.S. Cl. CPC G02B 5/28

(57) ABSTRACT

An optical filter includes a substrate, an adhesion layer formed on the substrate, and a matching composite layer formed on the adhesion layer and including a plurality of first refraction layers, a plurality of second refraction layers, and a plurality of third refraction layers. A quantity of the second refraction layers is less than that of the first refraction layers, and is less than that of the third refraction layers. A refractive index of the first refraction layer is greater than that of the adhesion layer. A refractive index of the second refraction layer is greater than that of the first refraction layer, and is less than that of the third refraction layer. Two of the second refraction layers sandwich one of the first refraction layers therebetween, and are sandwiched between two of the third refraction layers, so as to be jointly defined as a bidirectional incremental module.

### CROSS-REFERENCE TO RELATED PATENT APPLICATION

This application claims the benefit of priority to Taiwan Patent Application No. 112141164, filed on Oct. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a filter, and more particularly to an optical filter.

### BACKGROUND OF THE DISCLOSURE

A conventional optical filter includes a plurality of refraction layers that are stacked in sequence and that have two refractive indexes having a relatively large difference therebetween. However, the configuration of the conventional optical filter is gradually unable to meet different requirements.

### SUMMARY OF THE DISCLOSURE

In response to the above-referenced technical inadequacies, the present disclosure provides an optical filter for effectively improving on the issues associated with conventional optical filters.

In order to solve the above-mentioned problems, one of the technical aspects adopted by the present disclosure is to provide an optical filter, which includes a substrate, an adhesion layer formed on the substrate and having a refractive index being less than 1.42, and a matching composite layer that is formed on the adhesion layer and that includes an N number of films stacked in sequence. Moreover, N is a positive integer, and the N number of the films include a plurality of first refraction layers, a plurality of second refraction layers, and a plurality of third refraction layers. Each of the first refraction layers has a first refractive index that is greater than the refractive index of the adhesion layer. Each of the second refraction layers has a second refractive index that is greater than the first refractive index, and a quantity of the second refraction layers is less than a quantity of the first refraction layers. Each of the third refraction layers has a third refractive index that is greater than the second refractive index, and the quantity of the second refraction layers is less than a quantity of the third refraction layers. The matching composite layer is connected to the adhesion layer through one of the third refraction layers that is defined as a first film, and one of the first refraction layers is arranged on one end of the matching composite layer away from the adhesion layer and is defined as an N^{th} film. Two of the second refraction layers adjacent to each other sandwich one of the first refraction layers therebetween, and are sandwiched between two of the third refraction layers so as to be jointly defined as a bidirectional incremental module.

In order to solve the above-mentioned problems, another one of the technical aspects adopted by the present disclosure is to provide an optical filter, which includes a substrate, an adhesion layer formed on the substrate and having a refractive index being less than 1.42, and a matching composite layer that is formed on the adhesion layer and that includes an N number of films stacked in sequence. Moreover, N is a positive integer, and the N number of the films include a plurality of first refraction layers, a plurality of second refraction layers, and a plurality of third refraction layers. Each of the first refraction layers has a first refractive index that is greater than the refractive index of the adhesion layer. The second refraction layer has a second refractive index that is greater than the first refractive index. Each of the third refraction layers has a third refractive index that is greater than the second refractive index. The matching composite layer is connected to the adhesion layer through one of the third refraction layers that is defined as a first film, and one of the first refraction layers is arranged on one end of the matching composite layer away from the adhesion layer and is defined as an N^{th} film. The second refraction layer is sandwiched between one of the first refraction layers and one of the third refraction layers so as to be jointly defined as a unidirectional incremental module.

In order to solve the above-mentioned problems, yet another one of the technical aspects adopted by the present disclosure is to provide an optical filter, which includes a substrate, an adhesion layer, and a matching composite layer. The substrate has a first surface and a second surface that is opposite to the first surface. The adhesion layer is formed on the first surface of the substrate and has a refractive index being less than 1.42. The matching composite layer is formed on the adhesion layer and the second surface of the substrate, and the matching composite layer includes a plurality of films. The films include a plurality of first refraction layers, a plurality of second refraction layers, and a plurality of third refraction layers. Each of the first refraction layers has a first refractive index that is greater than the refractive index of the adhesion layer. Each of the second refraction layers has a second refractive index that is greater than the first refractive index, and a quantity of the second refraction layers is less than a quantity of the first refraction layers. Each of the third refraction layers has a third refractive index that is greater than the second refractive index, and the quantity of the second refraction layers is less than a quantity of the third refraction layers. The films include an N number of front films sequentially stacked on the adhesion layer and an M number of rear films that are sequentially stacked on the second surface of the substrate, and any one of N and M is a positive integer. The N number of the front films are connected to the adhesion layer through one of the third refraction layers thereof that is defined as a first front film. One of the first refraction layers is arranged on one end of the N number of the front films away from the adhesion layer and is defined as an N^{th} front film. In the N number of the front films, two of the second refraction layers adjacent to each other sandwich one of the first refraction layers therebetween, and are sandwiched between two of the third refraction layers so as to be jointly defined as a bidirectional incremental module.

Therefore, the optical filter of the present disclosure is provided with the bidirectional incremental module that has not been published in the relevant art, and the bidirectional incremental module has a refractive index that gradually increases from the first refraction layer thereof in two opposite directions, thereby adjusting a distribution of refractive index of the matching composite layer for enabling a design of the optical filter to meet various different requirements.

Moreover, in the optical filter of the present disclosure, the arrangement and the structural cooperation of the unidirectional incremental module can be provided to adjust the distribution of the refractive index of the matching composite layer for enabling a design of the optical filter to meet various different requirements.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic planar view of an optical filter according to a first embodiment of the present disclosure;

FIG. 2 is a chart showing a configuration of the optical filter of FIG. 1;

FIG. 3 is a schematic planar view of the optical filter according to a second embodiment of the present disclosure;

FIG. 4 is a chart showing the configuration of the optical filter of FIG. 3;

FIG. 5 is a schematic planar view of the optical filter according to a third embodiment of the present disclosure;

FIG. 6 is a chart showing one configuration of the optical filter of FIG. 5; and

FIG. 7 is a schematic simulation diagram showing the optical filter of FIG. 5 being simulated at different angles.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

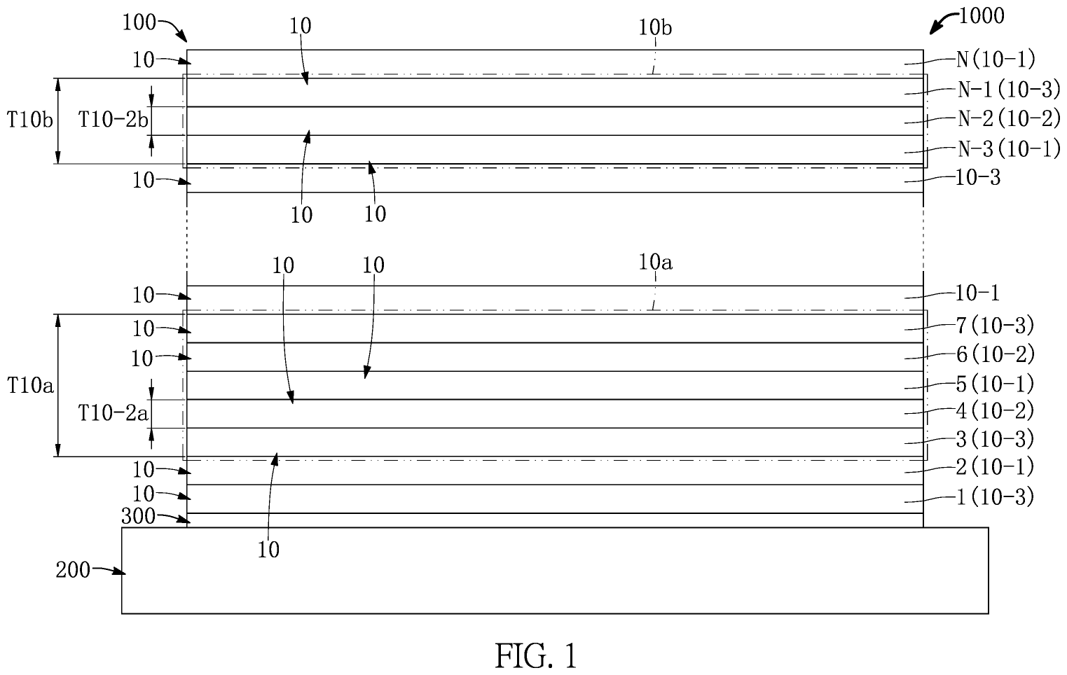

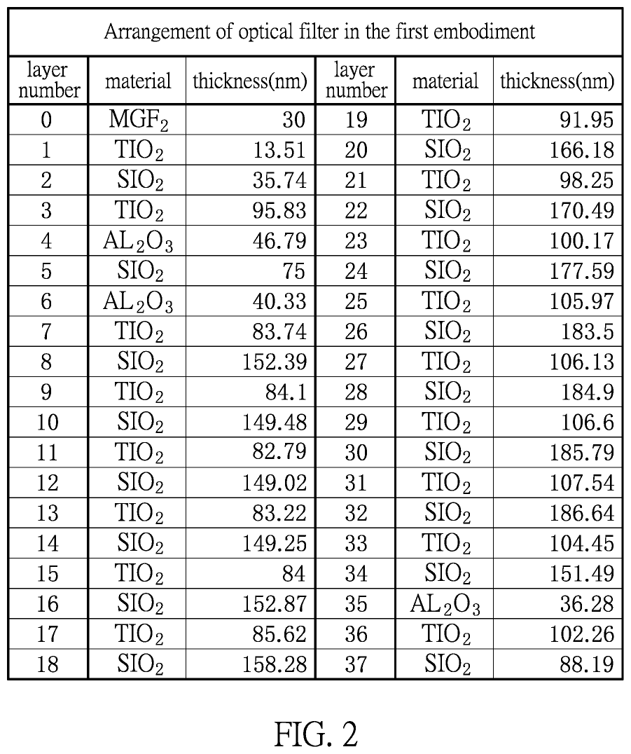

Referring to FIG. 1 and FIG. 2, a first embodiment of the present disclosure provides an optical filter 1000 that is preferably a flat sheet structure. The optical filter 1000 in the present embodiment can be applied to a visible light (having a wavelength of 420 nm to 680 nm).

In the present embodiment, the optical filter 1000 includes a substrate 200, an adhesion layer 300 formed on the substrate 200, and a matching composite layer 100 that is formed on the adhesion layer 300. The substrate 200 can be a glass substrate, and the matching composite layer 100 is connected to the substrate 200 through the adhesion layer 300, but the present disclosure is not limited thereto.

Specifically, the matching composite layer 100 includes an N number of films 10 stacked in sequence. The N number of the films 10 are preferably stacked along a thickness direction thereof, and lateral edges of the N number of the films 10 are flush with each other and are preferably flush with a lateral edge of the adhesion layer 300. Moreover, N is a positive integer (e.g., N can be within a range from 30 to 50), and N provided by the present embodiment is 37 (e.g., the films 10 and the adhesion layer 300 in the present embodiment are totally 38 layers), but the present disclosure is not limited thereto.

Furthermore, the N number of the films 10 can be divided into a plurality of first refraction layers 10-1, a plurality of second refraction layers 10-2, and a plurality of third refraction layers 10-3 according to refractive indexes thereof. Each of the first refraction layers 10-1 has a first refractive index that is greater than a refractive index of the adhesion layer 300. Each of the second refraction layers 10-2 has a second refractive index that is greater than the first refractive index. Each of the third refraction layers 10-3 has a third refractive index that is greater than the second refractive index.

In addition, in order to clearly describe a configuration of the matching composite layer 100, the films 10 can be renamed (or redefined) according to the stacked sequence thereof. In other words, the matching composite layer 100 is connected to the adhesion layer 300 through one of the third refraction layers 10-3 that is defined as a first film 1, and one of the first refraction layers 10-1 is arranged on one end of the matching composite layer 100 away from the adhesion layer 300 and is defined as an N^{th} film N.

In the present embodiment, the refractive index of the adhesion layer 300 is less than 1.42 (e.g., the refractive index of the adhesion layer 300 being within a range from 1.35 to 1.42), the first refractive index can be within a range from 1.45 to 1.52, the second refractive index can be within a range from 1.62 to 1.71, and the third refractive index can be within a range from 2.2 to 2.8. In other words, the optical filter 1000 in the present embodiment is formed by stacking four kinds of optical films that have different refractive indexes, thereby providing various optical configurations and structures.

It should be noted that any one of the adhesion layer 300, the first refraction layer 10-1, the second refraction layer 10-2, and the third refraction layer 10-3 in the following description is described by a possible material for clearly describing the present embodiment, but the present disclosure is not limited thereto. For example, the adhesion layer 300 can be a magnesium fluoride (MgF₂) layer, the first refraction layer 10-1 can be a silicon dioxide (SiO₂) layer, the second refraction layer 10-2 can be an alumina (Al₂O₃) layer, and the third refraction layer 10-3 can be a titanium dioxide (TiO₂) layer.

Moreover, a quantity of the second refraction layers 10-2 is less than a quantity of the first refraction layers 10-1, and is less than a quantity of the third refraction layers 10-3. In the present embodiment, the quantity of the second refraction layers 10-2 in the matching composite layer 100 is three, and the three second refraction layers 10-2 are in cooperation with part of the first refraction layers 10-1 and part of the second refraction layers 10-2 so as to form a bidirectional incremental module 10a and a unidirectional incremental module 10b, but the present disclosure is not limited thereto. For example, in other embodiments of the present disclosure not shown in the drawings, a quantity of the second refraction layers 10-2 can be two or at least four; or, only one of the bidirectional incremental module 10a and the unidirectional incremental module 10b is applied in the matching composite layer 100.

In the present embodiment, two of the second refraction layers 10-2 adjacent to each other sandwich one of the first refraction layers 10-1 therebetween, and are sandwiched between two of the third refraction layers 10-3 so as to be jointly defined as the bidirectional incremental module 10a. In the bidirectional incremental module 10a, any one of the two second refraction layers 10-2 is sandwiched between the first refraction layer 10-1 and the third refraction layer 10-3, so that a refractive index of the bidirectional incremental module 10a can gradually increase in two opposite directions.

In summary, the optical filter 1000 of the present embodiment is provided with the bidirectional incremental module 10a that has not been published in the relevant art, and the refractive index of the bidirectional incremental module 10a gradually increases from the corresponding first refraction layer 10-1 in two opposite directions, thereby adjusting a distribution of refractive index of the matching composite layer 100 for enabling a design of the optical filter 1000 to meet various different requirements.

Moreover, the unidirectional incremental module 10b in the present embodiment is preferably arranged away from the bidirectional incremental module 10a. Specifically, one of the second refraction layers 10-2 arranged away from the bidirectional incremental module 10a is sandwiched between one of the first refraction layers 10-1 and one of the third refraction layers 10-3 so as to be jointly defined as the unidirectional incremental module 10b, such that a refractive index of the unidirectional incremental module 10b can gradually increase in one direction.

Accordingly, the optical filter 1000 in the present embodiment having the bidirectional incremental module 10a can further include the unidirectional incremental module 10b, so that the arrangement and the structural cooperation between the bidirectional incremental module 10a and the unidirectional incremental module 10b (e.g., the bidirectional incremental module 10a and the unidirectional incremental module 10b being respectively arranged on two opposite sides of the matching composite layer 100) can be provided to adjust the distribution of the refractive index of the matching composite layer 100 for enabling a design of the optical filter 1000 to meet various different requirements.

It should be noted that the films 10 of the matching composite layer 100 other than that of the bidirectional incremental module 10a and the unidirectional incremental module 10b are arranged by having the first fraction layers 10-1 and the third refraction layers 10-3 be staggeredly stacked with each other (i.e., any one of the first refraction layers 10-1 being sandwiched between two of the third refraction layers 10-3 adjacent to each other).

Specifically, when light enters into the optical filer 1000 of the present embodiment by an angle that is changed from 90 degrees to 60 degrees, the bidirectional incremental module 10a and the unidirectional incremental module 10b preferably have at least part of the following features for enabling the optical filer 1000 to have a lower average reflectance, but the present disclosure is not limited thereto.

The bidirectional incremental module 10a is arranged adjacent to the first film 1, and the unidirectional incremental module 10b is arranged adjacent to the N^{th} film N. Moreover, a quantity and a thickness of the films 10 arranged between the bidirectional incremental module 10a and the first film 1 are different from a quantity and a thickness of the films 10 arranged between the unidirectional incremental module 10b and the N^{th} film N.

Specifically, the bidirectional incremental module 10a and the first film 1 are provided with one of the first refraction layers 10-1 (e.g., a second film 2) sandwiched therebetween, and the unidirectional incremental module 10b is connected to the N^{th} film N through the third refraction layer 10-3 thereof. In other words, the films 10 of the bidirectional incremental module 10a in the present embodiment are a third film 3 to a seventh film 7, and the films 10 of the unidirectional incremental module 10b are an N−3th film N−3 to N−1th film N−1.

Furthermore, a thickness T10a of the bidirectional incremental module 10a in the present embodiment is within a range from 165% to 180% of a thickness T10b of the unidirectional incremental module 10b, and a thickness T10-2a of any one of the two of the second refraction layers 10-2 in the bidirectional incremental module 10a is greater than a thickness T10-2b of the second refraction layer 10-2 in the unidirectional incremental module 10b.

Specifically, the adhesion layer 300 and the matching composite layer 100 of the optical filter 1000 in the present embodiment are provided by a configuration as shown in FIG. 2. Accordingly, after a simulation experiment under light (e.g., a visible light) entering into the optical filer 1000 by an angle that is changed from 90 degrees to 60 degrees, the optical filter 1000 can have an average reflectance being less than 1%.

### Second Embodiment

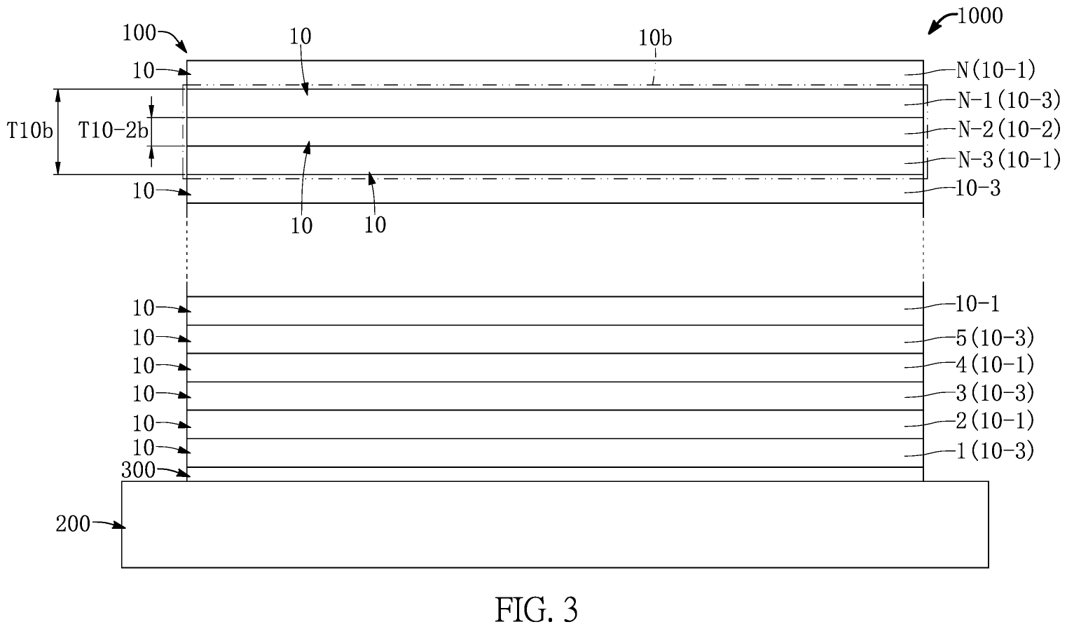

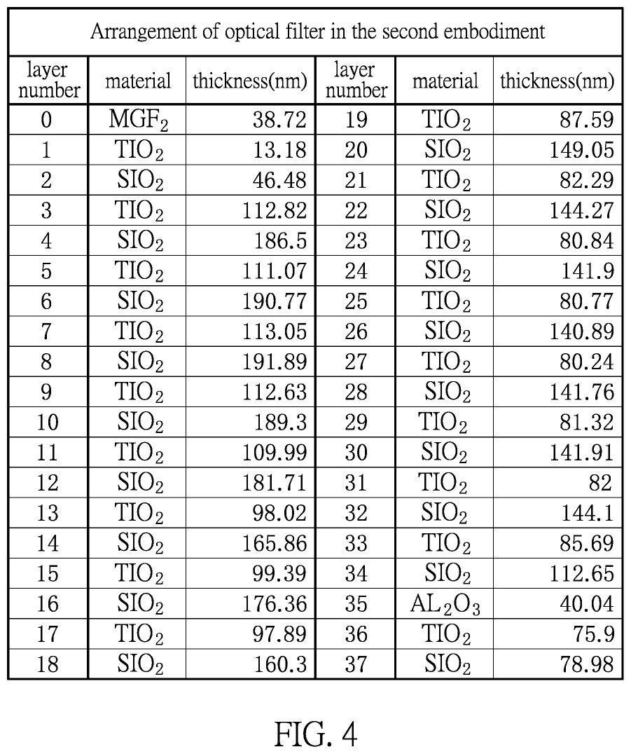

Referring to FIG. 3 and FIG. 4, a second embodiment of the present disclosure, which is similar to the first embodiment of the present disclosure, is provided. For the sake of brevity, descriptions of the same components in the first and second embodiments of the present disclosure will be omitted herein, and the following description only discloses different features between the first and second embodiments.

In the present embodiment, N is within a range from 30 to 50, and a quantity of the second refraction layer 10-2 in the matching composite layer 100 is only one. Moreover, the second refraction layer 10-2 is sandwiched between one of the first refraction layers 10-1 and one of the third refraction layers 10-3 so as to be jointly defined as a unidirectional incremental module 10b. In other words, a quantity of the films 10 of the optical filter 1000 provided by the present embodiment can be equal to that of the first embodiment, but the optical filter 1000 of the present embodiment excludes the bidirectional incremental module 10a described in the first embodiment (as shown in FIG. 1.)

It should be noted that the films 10 of the matching composite layer 100 other than that of the bidirectional incremental module 10a and the unidirectional incremental module 10b are arranged by staggeredly stacking the first fraction layers 10-1 and the third refraction layers 10-3 (i.e., any one of the first refraction layers 10-1 being sandwiched between two of the third refraction layers 10-3 adjacent to each other).

Specifically, the adhesion layer 300 and the matching composite layer 100 of the optical filter 1000 in the present embodiment are provided by a configuration as shown in FIG. 4. Accordingly, after a simulation experiment under light (e.g., a visible light) entering into the optical filer 1000 by an angle that is changed from 90 degrees to 60 degrees, the optical filter 1000 can have an average reflectance being less than 2%.

Accordingly, in the optical filter 1000 of the present embodiment, the arrangement and the structural cooperation of the unidirectional incremental module 10b can be provided to adjust the distribution of the refractive index of the matching composite layer 100 for enabling a design of the optical filter 1000 to meet various different requirements.

### Third Embodiment

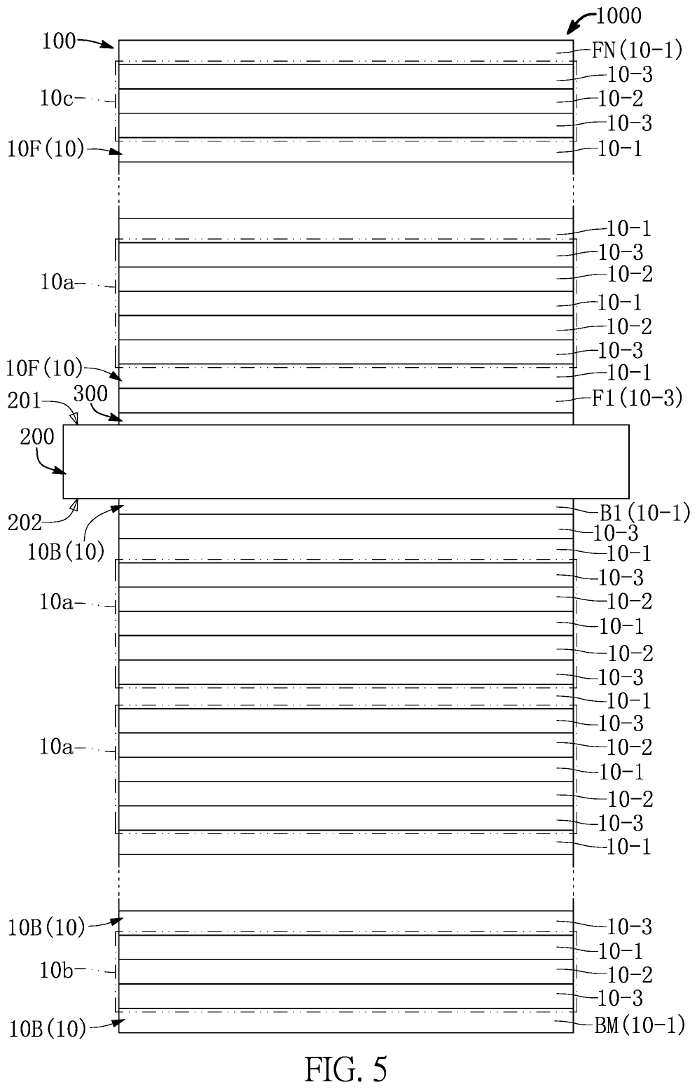

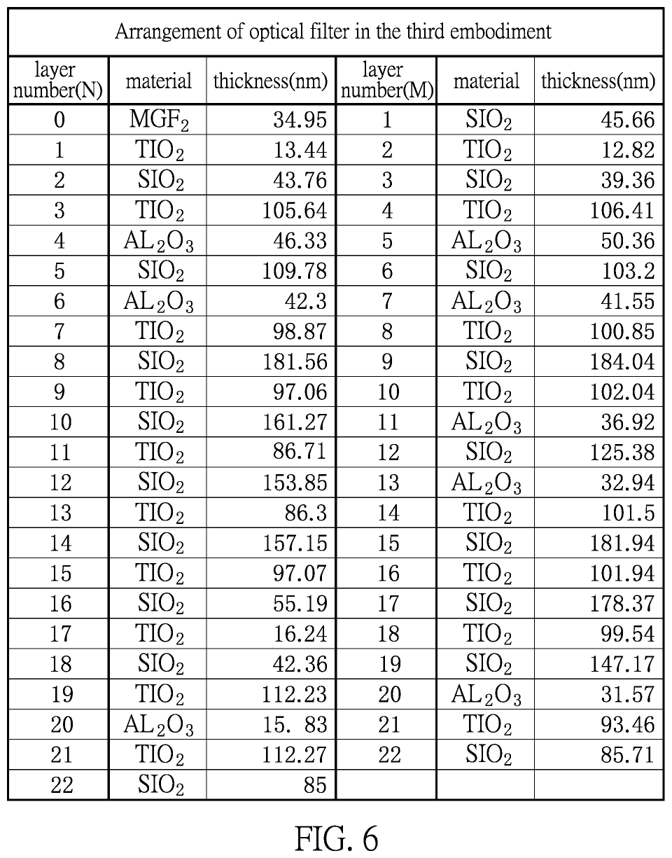

Referring to FIG. 5 to FIG. 7, a third embodiment of the present disclosure, which is similar to the first embodiment of the present disclosure, is provided. For the sake of brevity, descriptions of the same components in the first and third embodiments of the present disclosure will be omitted herein, and the following description only discloses different features between the first and third embodiments.

In the present embodiment, the substrate 200 has a first surface 201 and a second surface 202 that is opposite to the first surface 201. The adhesion layer 300 is formed on the first surface 201 of the substrate 200, and the matching composite layer 100 is formed on the adhesion layer 300 and the second surface 202 of the substrate 200. The matching composite layer 100 includes a plurality of films 10, and the films 10 include a plurality of first refraction layers 10-1, a plurality of second refraction layers 10-2, and a plurality of third refraction layers 10-3. Moreover, the properties and the materials of the first refraction layers 10-1, the second refraction layers 10-2, and the third refraction layers 10-3 in the present embodiment are substantially identical to those of the first embodiment, and are not described again for the sake of brevity.

Specifically, the films 10 in the present embodiment can be divided into an N number of front films 10F sequentially stacked on the adhesion layer 300 and an M number of rear films 10B that are sequentially stacked on the second surface 202 of the substrate 200. Moreover, any one of N and M is a positive integer, a difference between N and M is preferably less than or equal to 5, and any one of N and M is within a range from 30 to 50. In the present embodiment, any one of the positive integers N and M is 22, but the present disclosure is not limited thereto.

In order to clearly describe the configuration of the matching composite layer 100, the front films 10F and the rear films 10B can be renamed (or redefined) according to the stacked sequence thereof. Specifically, the N number of the front films 10F are connected to the adhesion layer 300 through one of the third refraction layers 10-3 thereof that is defined as a first front film F1, and one of the first refraction layers 10-1 is arranged on one end of the N number of the front films 10F away from the adhesion layer 300 and is defined as an N^{th} front film FN. Moreover, the M number of the rear films 10B are connected to the second surface 202 of the substrate 200 through one of the first refraction layers 10-1 thereof that is defined as a first rear film B1, and one of the first refraction layers 10-1 is arranged on one end of the M number of the rear films 10B away from the second surface 202 of the substrate 200 and is defined as an M^{th} rear film BM.

In the present embodiment, a quantity of the second refraction layers 10-2 in the matching composite layer 100 is eight, three of the eight second refraction layers 10-2 belong to the N number of the front films 10F and cooperate with part of the first refraction layers 10-1 and part of the second refraction layers 10-2 to form a bidirectional incremental module 10a and a bidirectional incremental sub-module 10c in the N number of the front films 10F, and the other five second refraction layers 10-2 belong to the M number of the rear films 10B and are cooperate with part of the first refraction layers 10-1 and part of the second refraction layers 10-2 to form two bidirectional incremental modules 10a and a unidirectional incremental module 10b in the M number of the rear films 10B, but the present disclosure is not limited thereto.

For example, in other embodiments of the present disclosure not shown in the drawings, the quantity of the second refraction layers 10-2 can be at least two according to design requirements; or, the N number of the front films 10F can be provided without the bidirectional incremental sub-module 10c, and the M number of the rear films 10B can be provided without at least one of the two bidirectional incremental modules 10a and/or the unidirectional incremental module 10b according to design requirements.

In the N number of the front films 10F, two of the second refraction layers 10-2 adjacent to each other sandwich one of the first refraction layers 10-1 therebetween, and are sandwiched between two of the third refraction layers 10-3 so as to be jointly defined as the bidirectional incremental module 10a. Moreover, in the N number of the front films 10F, one of the second refraction layers 10-2 arranged away from the bidirectional incremental module 10a is sandwiched between two of the third refraction layers 10-3 so as to be jointly defined as the bidirectional incremental sub-module 10c.

Specifically, in the N number of the front films 10F, the bidirectional incremental module 10a and the first front film F1 are provided with one of the first refraction layers 10-1 sandwiched therebetween, and the bidirectional incremental sub-module 10c is connected to the N^{th} front film FN. In other words, the bidirectional incremental module 10a and the bidirectional incremental sub-module 10c are respectively arranged on two opposite sides of the N number of the front films 10F.

In the M number of the rear films 10B, two of the second refraction layers 10-2 adjacent to each other sandwich one of the first refraction layers 10-1 therebetween, and are sandwiched between two of the third refraction layers 10-3, so as to be jointly defined as one of the two bidirectional incremental modules 10a. Furthermore, in the M number of the rear films 10B, one of the second refraction layers 10-2 arranged away from the substrate 200 is sandwiched between one of the first refraction layers 10-1 and one of the third refraction layers 10-3 so as to be jointly defined as the unidirectional incremental module 10b.

Specifically, in the M number of the rear films 10B, one of the two bidirectional incremental modules 10a and the first rear film B1 are provided with one of the first refraction layer 10-1 and one of the third refraction layers 10-3 sandwiched therebetween, and the unidirectional incremental module 10b is connected to the M^{th} rear film BM. In other words, the one of the two bidirectional incremental modules 10a and the unidirectional incremental module 10b are respectively arranged on two opposite sides of the M number of the rear films 10B. Furthermore, in a part of the M number of the rear films 10B between the one of the two bidirectional incremental modules 10a and the unidirectional incremental module 10b, two of the second refraction layers 10-2 adjacent to each other sandwich one of the first refraction layers 10-1 therebetween and are sandwiched between two of the third refraction layers 10-3 so as to be jointly defined as another of the two bidirectional incremental modules 10a.

In addition, in the M number of the rear films 10B, only one of the first refraction layers 10-1 is sandwiched between the two bidirectional incremental modules 10a, thereby reinforcing the cooperative effect between the two bidirectional incremental modules 10a.

In other words, a thickness of each of the two bidirectional incremental modules 10a in the M number of the rear films 10B is within a range from 90% to 110% of a thickness of the bidirectional incremental module 10a in the N number of the front films 10F. Moreover, a distance between the second surface 202 of the substrate 200 and the bidirectional incremental module 10a of the M number of the rear films 10b adjacent to the substrate 200 is within a range from 90% to 110% of a distance between the bidirectional incremental module 10a of the N number of the front films 10F and the first surface 201 of the substrate 200.

It should be noted that the films 10 of the matching composite layer 100 other than that of the bidirectional incremental modules 10a, the unidirectional incremental module 10b, and the bidirectional incremental sub-module 10c are arranged by staggeredly stacking the first fraction layers 10-1 and the third refraction layers 10-3 (i.e., any one of the first refraction layers 10-1 being sandwiched between two of the third refraction layers 10-3 adjacent to each other).

In summary, the matching composite layer 100 of the optical filter 1000 in the present embodiment are divided into two parts respectively disposed on two opposite sides of the substrate 200, so that the bidirectional incremental modules 10a, the unidirectional incremental module 10b, and the bidirectional incremental sub-module 10c can be cooperated with each other to adjust the distribution of the refractive index of the matching composite layer 100 for enabling a design of the optical filter 1000 to meet various different requirements.

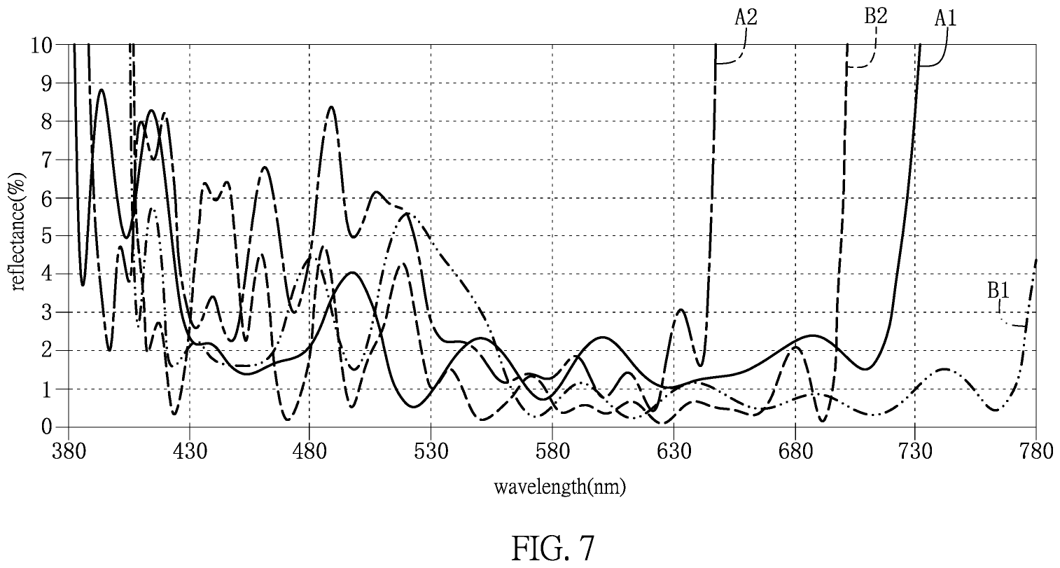

Specifically, as shown in FIG. 7, curved lines A1, B1 show simulation results of the optical filter 1000 of the present embodiment under different angles, and curved lines A2, B2 show simulation results of a conventional optical filter under different angles, in which the conventional optical filter includes a board and refraction layers stacked on one side of the board and does not have any one of the bidirectional incremental module 10a, the unidirectional incremental module 10b, and the bidirectional incremental sub-module 10c.

Accordingly, when the optical filter 1000 of the present embodiment is used in a wavelength range from 435 nm to 630 nm, the reflectance can be decreased by 2.8%, the ripples can be effectively reduced, and a lower reflective range can be expanded by approximately 70 nm. Specifically, when a spectrum of light is within a range from 435 nm to 630 nm, the optical film 1000 of the present embodiment has a better performance than the conventional optical filter and can expand the spectrum to be within a range from 400 nm to 700 nm.

### Beneficial Effects of the Embodiments

In conclusion, the optical filter of the present disclosure is provided with the bidirectional incremental module that has not been published in the relevant art, and the refractive index of the bidirectional incremental module gradually increases from the corresponding first refraction layer in two opposite directions, thereby adjusting the distribution of the refractive index of the matching composite layer for enabling a design of the optical filter to meet various different requirements.

Moreover, in the optical filter of the present disclosure, the arrangement and the structural cooperation of the unidirectional incremental module can be provided to adjust the distribution of the refractive index of the matching composite layer for enabling a design of the optical filter to meet various different requirements.

In addition, the optical filter in the present disclosure can further include the unidirectional incremental module, so that the arrangement and the structural cooperation between the bidirectional incremental module and the unidirectional incremental module (e.g., the bidirectional incremental module and the unidirectional incremental module being respectively arranged on two opposite sides of the matching composite layer) can be provided to adjust the distribution of the refractive index of the matching composite layer for enabling a design of the optical filter to meet various different requirements.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical filter, comprising:
a substrate;
an adhesion layer formed on the substrate and having a refractive index being less than 1.42; and
a matching composite layer formed on the adhesion layer and including an N number of films stacked in sequence, wherein N is a positive integer, and the N number of the films include:
a plurality of first refraction layers each having a first refractive index that is greater than the refractive index of the adhesion layer;
a plurality of second refraction layers each having a second refractive index that is greater than the first refractive index, wherein a quantity of the second refraction layers is less than a quantity of the first refraction layers; and
a plurality of third refraction layers each having a third refractive index that is greater than the second refractive index, wherein the quantity of the second refraction layers is less than a quantity of the third refraction layers;
wherein the matching composite layer is connected to the adhesion layer through one of the third refraction layers that is defined as a first film, and one of the first refraction layers is arranged on one end of the matching composite layer away from the adhesion layer and is defined as an N^{th} film; and
wherein two of the second refraction layers adjacent to each other sandwich one of the first refraction layers therebetween, and are sandwiched between two of the third refraction layers, so as to be jointly defined as a bidirectional incremental module.

2. The optical filter according to claim 1, wherein one of the second refraction layers arranged away from the bidirectional incremental module is sandwiched between one of the first refraction layers and one of the third refraction layers, so as to be jointly defined as a unidirectional incremental module.

3. The optical filter according to claim 2, wherein the bidirectional incremental module and the first film are provided with one of the first refraction layers sandwiched therebetween, and the unidirectional incremental module is connected to the N^{th} film.

4. The optical filter according to claim 2, wherein the bidirectional incremental module is arranged adjacent to the first film, and the unidirectional incremental module is arranged adjacent to the N^{th} film.

5. The optical filter according to claim 4, wherein a quantity and a thickness of the films arranged between the bidirectional incremental module and the first film are different from a quantity and a thickness of the films arranged between the unidirectional incremental module and the N^{th} film.

6. The optical filter according to claim 2, wherein a thickness of the bidirectional incremental module is within a range from 165% to 180% of a thickness of the unidirectional incremental module, and a thickness of any one of the two of the second refraction layers in the bidirectional incremental module is greater than a thickness of the second refraction layer in the unidirectional incremental module.

7. The optical filter according to claim 1, wherein the refractive index of the adhesion layer is within a range from 1.35 to 1.42, the first refractive index is within a range from 1.45 to 1.52, the second refractive index is within a range from 1.62 to 1.71, and the third refractive index is within a range from 2.2 to 2.8.

8. The optical filter according to claim 1, wherein N is within a range from 30 to 50, and the quantity of the second refraction layers in the matching composite layer is three.

9. An optical filter, comprising:
a substrate;
an adhesion layer formed on the substrate and having a refractive index being less than 1.42; and
a matching composite layer formed on the adhesion layer and including an N number of films stacked in sequence, wherein N is a positive integer, and the N number of the films include:
a plurality of first refraction layers each having a first refractive index that is greater than the refractive index of the adhesion layer;
a second refraction layer having a second refractive index that is greater than the first refractive index; and
a plurality of third refraction layers each having a third refractive index that is greater than the second refractive index;
wherein the matching composite layer is connected to the adhesion layer through one of the third refraction layers that is defined as a first film, and one of the first refraction layers is arranged on one end of the matching composite layer away from the adhesion layer and is defined as an N^{th} film; and
wherein the second refraction layer is sandwiched between one of the first refraction layers and one of the third refraction layers, so as to be jointly defined as a unidirectional incremental module.

10. The optical filter according to claim 9, wherein N is within a range from 30 to 50, and a quantity of the second refraction layer in the matching composite layer is only one.

11. An optical filter, comprising:
a substrate having a first surface and a second surface that is opposite to the first surface;
an adhesion layer formed on the first surface of the substrate and having a refractive index being less than 1.42; and
a matching composite layer formed on the adhesion layer and the second surface of the substrate, wherein the matching composite layer includes a plurality of films, and the films include:
a plurality of first refraction layers each having a first refractive index that is greater than the refractive index of the adhesion layer;
a plurality of second refraction layers each having a second refractive index that is greater than the first refractive index, wherein a quantity of the second refraction layers is less than a quantity of the first refraction layers; and
a plurality of third refraction layers each having a third refractive index that is greater than the second refractive index, wherein the quantity of the second refraction layers is less than a quantity of the third refraction layers;
wherein the films include an N number of front films sequentially stacked on the adhesion layer and an M number of rear films that are sequentially stacked on the second surface of the substrate, and any one of N and M is a positive integer, wherein the N number of the front films are connected to the adhesion layer through one of the third refraction layers thereof that is defined as a first front film, and wherein one of the first refraction layers is arranged on one end of the N number of the front films away from the adhesion layer and is defined as an N^{th} front film; and
wherein, in the N number of the front films, two of the second refraction layers adjacent to each other sandwich one of the first refraction layers therebetween, and are sandwiched between two of the third refraction layers, so as to be jointly defined as a bidirectional incremental module.

12. The optical filter according to claim 11, wherein, in the N number of the front films, one of the second refraction layers arranged away from the bidirectional incremental module is sandwiched between two of the third refraction layers, so as to be jointly defined as a bidirectional incremental sub-module.

13. The optical filter according to claim 12, wherein, in the N number of the front films, the bidirectional incremental module and the first front film are provided with one of the first refraction layers sandwiched therebetween, and the bidirectional incremental sub-module is connected to the N^{th} front film.

14. The optical filter according to claim 11, wherein, in the M number of the rear films, two of the second refraction layers adjacent to each other sandwich one of the first refraction layers therebetween and are sandwiched between two of the third refraction layers so as to be jointly defined as a bidirectional incremental module.

15. The optical filter according to claim 14, wherein a thickness of the bidirectional incremental module in the M number of the rear films is within a range from 90% to 110% of a thickness of the bidirectional incremental module in the N number of the front films.

16. The optical filter according to claim 14, wherein a distance between the bidirectional incremental module of the M number of the rear films and the second surface of the substrate is within a range from 90% to 110% of a distance between the bidirectional incremental module of the N number of the front films and the first surface of the substrate.

17. The optical filter according to claim 14, wherein, in the M number of the rear films, one of the second refraction layers arranged away from the substrate is sandwiched between one of the first refraction layers and one of the third refraction layers, so as to be jointly defined as a unidirectional incremental module.

18. The optical filter according to claim 17, wherein the M number of the rear films are connected to the second surface of the substrate through one of the first refraction layers thereof that is defined as a first rear film, wherein one of the first refraction layers is arranged on one end of the M number of the rear films away from the second surface of the substrate and is defined as an M^{th} rear film, and wherein, in the M number of the rear films, the bidirectional incremental module and the first rear film are provided with one of the first refraction layer and one of the third refraction layers sandwiched therebetween, and the unidirectional incremental module is connected to the M^{th} rear film.

19. The optical filter according to claim 17, wherein, in a part of the M number of the rear films between the bidirectional incremental module and the unidirectional incremental module, two of the second refraction layers adjacent to each other sandwich one of the first refraction layers therebetween, and are sandwiched between two of the third refraction layers, so as to be jointly defined as a bidirectional incremental module.

20. The optical filter according to claim 11, wherein the refractive index of the adhesion layer is within a range from 1.35 to 1.42, the first refractive index is within a range from 1.45 to 1.52, the second refractive index is within a range from 1.62 to 1.71, and the third refractive index is within a range from 2.2 to 2.8.

21. The optical filter according to claim 11, wherein a difference between N and M is less than or equal to 5, any one of N and M is within a range from 30 to 50, and the quantity of the second refraction layers in the matching composite layer is eight.
